(19) United States
(12) Patent Application Publication
(10) Pub. No.: US 2002/0038019 A1
(43) Pub. Date: Mar. 28, 2002

(54) Process for treating xanthan gums with glyoxal and xanthan products produced thereby

(76) Inventors: William S. Bousman, San Diego, CA (US); Catherine Bousman, San Diego, CA (US); Robert Raczkowski, Chula Vista, CA (US); Monica A. Garcia, Chula Vista, CA (US)

Correspondence Address: FITZPATRICK CELLA HARPER & SCINTO, 30 ROCKEFELLER PLAZA, NEW YORK, NY, 10112, US

(21) Appl. No.: 09/842,644

(22) Filed: Apr. 27, 2001

Related U.S. Application Data
(60) Provisional application No. 60/200,643, filed on Apr. 28, 2000.

(51) Int. Cl. C08B 37/00

(52) U.S. Cl. 536/114

(57) ABSTRACT

An improved process for treating xanthan gums with glyoxal for more complete dispersion in fluid systems comprising the steps of treating milled xanthan particles with a liquefied glyoxal composition. The liquefied glyoxal composition may comprise glyoxal, water and a hydration suppression agent such as salt, alcohol, ketones or mixtures thereof. This invention also relates to the xanthan products prepared by the process of this invention, which provide improved dispersability, hydration and filterability in liquids.

This application claims the benefit of U.S. Provisional Patent Application No. 60/200,643 filed Apr. 28, 2000.

### BACKGROUND OF THE INVENTION

1. Field of the Invention

The present invention relates to an improved process for treating xanthan gums with glyoxal and to the xanthan products produced thereby.

2. Related Background Art

Glyoxal is added to certain xanthan gums to render the xanthan particles dispersible in a fluid system prior to hydration and development of viscosity. Untreated xanthan particles will form gelled lumps when added to aqueous medium unless glyoxal is added to reduce hydrogen bonding of the xanthan polysaccharide with water and to allow for more complete dispersion. Glyoxal-treated xanthan products have great industrial application due to their ability to hydrate on demand, i.e. the ability to dissolve in fluid systems and impart viscosity upon raising pH to 8-10. Glyoxal-treated xanthan products also aid in the suspension of solid materials throughout the fluid system and have many applications in the oil drilling industry in workover and completion fluids, spacer fluids, foam drilling fluids and other uses well known in the art.

The treatment of xanthan gum with glyoxal involves several practical difficulties. Adding glyoxal to the fermentation broth of the xanthan gum prior to its precipitation necessarily incorporates the glyoxal into the final xanthan product. This process furthermore results in considerable glyoxal build-up in the process equipment and, in food-grade xanthan products, has been linked to off-taste problems. Glyoxal is unsuitable for use in food grade xanthan products. In insecticides, it is a known health hazard in quantities exceeding 3000 ppm. Glyoxal has also recently become an environmental concern in many countries, to the extent that it has now been banned in Norway.

In an alternative process, glyoxal can be sprayed onto the precipitated xanthan gum in the drying stage and then milled with the xanthan particles into a powder. This process however, fails to cover the xanthan particle surface completely since the precipitated xanthan particles are relatively large (pea-size) and will be further broken up to expose more surface area during milling. Furthermore, this process also allows much of the glyoxal to accumulate on the dryer surface, potentiating dryer malfunctions and fire hazards.

Both of the above processes fail to uniformly coat glyoxal on the surface of the xanthan product, and ultimately provide the xanthan product with poor dispersibility, hydration and filterability. In addition, the above processes require excessive amounts of glyoxal and/or leave glyoxal residue. The large amount of glyoxal present in the process equipment also results in excessive browning of the xanthan products. It would be desirable to develop a process for treating xanthan gums with glyoxal to provide a more uniform glyoxal coating of the xanthan product. It would further be desirable to develop a process for treating xanthan gums with glyoxal which requires lower quantities of glyoxal in order to provide the coated xanthan product. It would further be desirable to obtain a glyoxal-coated xanthan product with improved dispersibility characteristics and the ability to hydrate on demand.

### SUMMARY OF INVENTION

This invention relates to an improved process for treating xanthan gums with glyoxal for more complete dispersion in fluid systems. The process comprises the steps of treating milled xanthan particles with a liquefied glyoxal composition, wherein the liquefied glyoxal composition comprises glyoxal, water and a hydration suppression agent. The hydration suppression agent may be a salt, alcohol or ketone. This invention also relates to the xanthan products prepared by the process of this invention, which provide improved dispersability, hydration and filterability in fluid systems.

### DETAILED DESCRIPTION OF THE INVENTION

Glyoxal is the simplest dialdehyde. In pure form, glyoxal is very reactive, volatile at ambient temperature and difficult to use. It is usually sold either as a 40% aqueous solution or as an 80% solid pellet which are both forms that can be used in practical processes. In the aqueous state, the dialdehyde forms the hydrate form, as shown below, as well as many oligomers and cyclic complexes of this form.

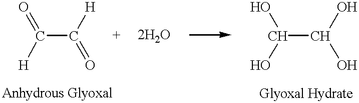

The xanthan gums used in this invention are hydrophilic polysaccharides which are obtained by the fermentation of appropriate nutrient media with microorganisms of the genus Xanthomonas. Such xanthan gums are well known in the art and are readily available. Exemplary xanthan gums include those derived from the bacteria Xanthomonas campestris, as well as Xanthomonas carotate, Xanthomonas incanae, Xanthomonas begoniae, Xanthomonas malverum, Xanthomonas vesicatoria, Xanthomonas papavericola, Xanthomonas translucens, Xanthomonas vasculorum and Xanthomonas hederae. When dissolved in water in low concentrations, xanthan gums impart a viscosity to the aqueous medium which is useful for a wide variety of applications, such as the manufacture of ingestible products, and in oil field drilling fluids. Xanthan viscosified solutions are particularly useful in applications where it is desirable to suspend solid materials in the aqueous medium.

The xanthan gums used in this invention have hydroxyl groups which are exposed on their polysaccharide backbone and which hydrogen bond in an aqueous medium, resulting in sticky gelled lumps. The structure of the Xanthan backbone is shown below:

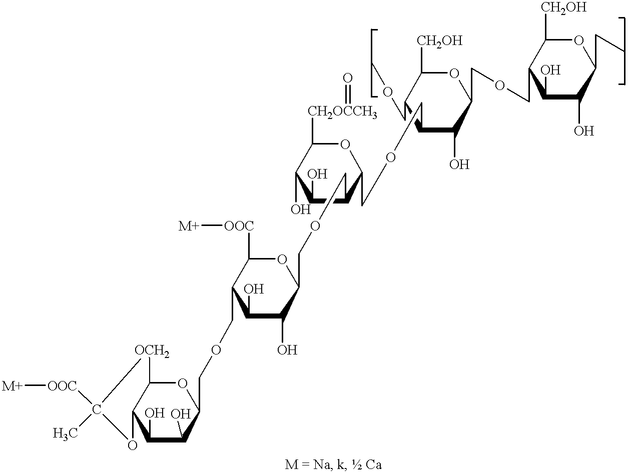

During commercial preparation of most xanthan gums, the solid xanthan gum is recovered by precipitation from the fermentation broth in which it is made. The precipitated xanthan fibers are then heated and dried, and milled to an appropriate particle size according to methods well-known in the art.

Glyoxal has particular utility in relation to xanthan because of its ability to form hemiacetals and acetals with ROH groups, as shown below:

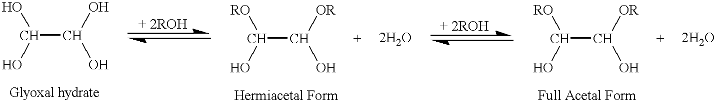

In the presence of the hydroxyl groups of xanthan gum, glyoxal will form hemiacetals and acetals and thereby prevent interaction of the xanthan hydroxyl groups with the aqueous medium. The kinetics of hemiacetal and acetal formation by reaction of glyoxal with xanthan are affected by a number of factors, including the presence of acid, heat, salt and the nature of the groups attached to the aldehyde carbonyls. Glyoxal can form hemiacetals with the hydroxyl groups of xanthan in the presence of acid, but acetal formation is limited. Without being bound by theory, it is believed that steric hindrance in the reaction of glyoxal with the hydroxyl groups on the xanthan polysaccharide make acetal formation difficult.

It has recently been discovered that a more uniform glyoxal coating of xanthan particles can be achieved by adding a liquefied glyoxal composition to the milled xanthan particles, wherein the liquefied glyoxal composition comprises glyoxal, water and a hydration suppression agent. The hydration suppression agent serves to suppress interaction of the xanthan gum with water during treatment with glyoxal. The hydration suppression agent can be a salt, alcohol or ketone.

The process first requires the presence of xanthan particles that have already undergone processing through fermentation, precipitation, drying, and milling to an appropriate mesh size. Preferably the xanthan particles are in the form of powder, with a maximum moisture content of 14%, most preferably 6-10%. Preferably the xanthan is milled to an average particle size of 20 mesh (˜841 μ) to 200 mesh (˜74 μ), and no more than 10% of the particles are smaller than 200 mesh (˜74 μ). Most preferably, the xanthan is milled to an average particle size of 20 mesh (˜841 μ) to 80 mesh (˜177 μ). If xanthan particles from different batches are to be used, then the xanthan particles should optionally be further blended to increase homogeneity, prior to treatment with glyoxal.

In the present invention, treatment of milled xanthan particles requires that delivery of glyoxal be in a liquid form, in order to evenly coat the particles. Water in the liquefied glyoxal composition has the potential however, to hydrate the xanthan during the coating process and cause it to form gelled lumps. Accordingly, the liquefied glyoxal composition must be sufficiently saturated with a salt, alcohol or ketone prior to treatment of the xanthan particles.

In one embodiment of this invention, the liquefied glyoxal composition comprises a mixture of glyoxal, water and a salt or a blend of salts. Preferably, the liquefied glyoxal salt composition comprises about 20-30% glyoxal, about 40-50% water, and about 20-40% salt, by total weight percent of the composition. The salt may be any salt, e.g. calcium chloride, magnesium chloride, sodium chloride, or any other suitable salt well-known in the art. Most preferably the salt is CaCl₂.

Preferably, the glyoxal is placed in the mixing vessel prior to addition of the salt and the reagents are mixed at a speed sufficient enough to create a vortex until all of the salt is dissolved. The temperature of the liquefied glyoxal salt composition may reach about 150° F. (66° C.) upon mixing without external heating. Preferably, the liquefied glyoxal salt composition is used within ten minutes of mixing, while the temperature remains at least about 125° F. (52° C.). The liquefied glyoxal salt composition is then added to the milled xanthan particles, preferably at a range of about 3,750 ppm to about 37,500 ppm, (glyoxal would comprise about 1,000 ppm to about 10,000 ppm). In a preferred embodiment, the liquefied glyoxal salt composition that is added to the xanthan particles comprises about 3,000 ppm glyoxal, about 4,500 ppm water, and about 3,750 ppm salt (CaCl₂).

In an alternative preferred embodiment, the liquefied glyoxal composition comprises a mixture of glyoxal, water, and an alcohol or ketone. The alcohol or ketone in this liquefied glyoxal composition will form hemiacetals and acetals with the hydroxyl groups on the xanthan gum backbone but will then evaporate upon drying to leave glyoxal bound to the xanthan. Preferably, the liquefied glyoxal alcohol or ketone composition comprises about 12-24% glyoxal, about 18-36% water, and about 40-70% alcohol or ketone, by total weight percent of the composition. Exemplary alcohols or ketones that may be used in the present invention include polyethyelene glycol, isopropanol, acetone and other suitable alcohols or ketones that are well-known in the art. Most preferably, the alcohol or ketone is isopropanol or acetone. The liquefied glyoxal alcohol or ketone composition is then added to the milled xanthan particles, preferably at a range of about 4,170 ppm to about 83,300 ppm, (glyoxal would comprise about 1,000 ppm to about 10,000 ppm). In a preferred embodiment of this method, the liquefied glyoxal composition that is added to the xanthan particles comprises about 7,500 ppm of water, about 5,000 ppm glyoxal, and about 12,500 ppm alcohol or ketone (isopropanol or acetone).

The liquefied glyoxal compositions described above are then sprayed onto the milled xanthan particles. Preferably, the treated particles are then heated to a range of about 100° F. (38° C.) to about 212° F. (100° C.) to initiate cross-linking, or formation of hemiacetals and acetals, of glyoxal to xanthan. Most preferably the treated particles are heated to a range of about 130° F. (54° C.) to about 200° F. (93° C.) for approximately 10-60 minutes to initiate cross-linking.

In a preferred embodiment, the glyoxal is sprayed onto the milled xanthan particles by a spray nozzle, while continuously blending the xanthan. Preferably, the spray nozzle provides spray droplets that are no larger than 500 μ in size, and most preferably the droplets are no larger than 200 μ in size. The time and pressure required for spraying will vary according to volume, but can be adjusted by one skilled in the art. The spraying is preferably done at a rate such that the xanthan particles are not hydrated by water, preferably in the range of about 0.1 gal/min to about 2 gal/min, and most preferably in the range of about 0.25 gal/min to about 0.5 gal/min. Blending of the xanthan particles can be accomplished by any ordinary blender at a low speed, according to methods well-known in the art. Preferably, blending is accomplished at a range of 10 rpm-50 rpm. The treated particles are then optionally sifted through a mesh screen to further spread glyoxal among the particles and promote reaction with xanthan. Continuous blending and repeated sifting of the treated particles are recommended to achieve a more uniform glyoxal coating, and tests for dispersability are suggested every thirty minutes until desired dispersability characteristics are achieved.

Tests for dispersability of the xanthan particles can be performed by visual discernment, ie. by the appearance of gelled lumps. The desired dispersability of the xanthan particles in the fluid system is largely a matter of preference.

The overall time required for treating the xanthan particles with glyoxal to achieve a desired dispersability may be adjusted by a number of parameters. As noted above, heating the milled xanthan particles to a range of about 100° F. (38° C.) to about 212° F. (100° C.) may speed reaction of glyoxal with xanthan. In addition, adjustment of the pH of the liquefied glyoxal composition to a range of pH 1-2.5 will also expedite reaction of glyoxal with xanthan, and can be accomplished by addition of citric acid or by other means well-known in the art.

Accordingly, the process of this invention for the treatment of xanthan particles with glyoxal comprises the step of spraying liquefied glyoxal composition onto milled xanthan particles. Preferably, spraying occurs while continuously blending the xanthan particles. The treated xanthan particles may optionally be heated, or may already be heated as in the reaction of glyoxal with salt, to a temperature range of about 100° F. (38° C.) to about 212° F. (100° C.). As a last step, the treated xanthan particles are sifted through an appropriate mesh size, with repeated sifting as desired. The xanthan product produced by the above process may then be dispersed in an aqueous medium by mixing with a high shear mixer or pressure drop homogenizer, or by other means well-known in the art.

It is anticipated that the method of treating xanthan gum with glyoxal as herein disclosed will also be suitable for the treatment of other fermentation-derived polysaccharides, for example, welan gum, rhamsan gum, gellan gum, and the like.

Other variations or modifications, which will be obvious to those skilled in the art, are within the scope and teachings of this invention. This invention is not to be limited except as set forth in the following claims.

### EXAMPLE 1

### Process of Treating Xanthan With Liquefied Glyoxal Salt Composition

1000 kg of Keltrol® xanthan particles (Kelco Biopolymers, San Diego, Calif.) were prepared according to methods well-known in the art and milled to a 40 mesh size (˜420 μ).

A liquefied glyoxal salt composition was prepared by adding 3.75 kg of CaCl₂ to 7.5 kg of an aqueous glyoxal solution comprising 40 wt % glyoxal and 60 wt % water (American Cyanamid of Parsippany, N.J.) and mixing in a small bucket. The liquefied composition was mixed at 250-500 rpm speed for about 10 minutes and then the entire contents were pumped directly to a spray nozzle.

The liquefied glyoxal was sprayed for 60-90 seconds onto the xanthan particles while continuously blending the xanthan. The treated xanthan particles were then blended until reaching a set temperature of about 130° F. (54° C.) and sifted through a 20 mesh screen.

Upon dispersing 2 g of the xanthan particles in 200 g of tap water, no lumps appeared. In contrast 100 lumps appeared upon dispersion of 2 g of the untreated xanthan particles in 200 g tap water.

### EXAMPLE 2

### Process of Treating Xanthan with Liquefied Glyoxal Alcohol Composition

1 kg of Keltrol® xanthan particles (Kelco Biopolymers, San Diego, Calif.) was prepared according to methods well-known in the art and milled to a 40 mesh size (˜420 /μ).

A liquefied glyoxal alcohol composition was prepared by first adding 12.5 g of an aqueous glyoxal solution comprising 40 wt % glyoxal and 60 wt % water (American Cyanamid of Parsippany, N.J.) to 12.5 g of isopropanol and mixing in a small bucket. The glyoxal was added to the xanthan composition at approximately 5,000 ppm. The liquefied composition was blended and then dripped onto the 1 kg of xanthan particles while stirring over a 1 to 2 minute period. The treated xanthan particles was then blended for 10 minutes, and then heated to a range of 130° F. (54° C.)-200° F. (93° C.) for approximately 10-60 minutes.

Upon dispersing 2 g of the xanthan particles in 200 g of tap water, no lumps were observed. In contrast 100 lumps appeared upon dispersion of 2 g of the untreated xanthan particles in 200 g tap water.

What is claimed:

1. A process for treating xanthan gum with glyoxal comprising the step of adding a liquefied glyoxal composition to milled xanthan particles, wherein the liquefied glyoxal comprises glyoxal, water and a hydration suppression agent.

2. The process of claim 1, wherein the milled xanthan particles have an average particle size of 20 mesh (˜841 μ) to 200 mesh (˜74 μ), and no more than 10% of the xanthan particles are smaller than 200 mesh (˜74 μ).

3. The process of claim 2, wherein the milled xanthan particles have an average particle size of 20 mesh (˜841 μ) to 80 mesh (˜177 μ).

4. The process of claim 1, wherein the hydration suppression agent is selected from the group consisting of salts, alcohols, ketones or mixtures thereof.

5. The process of claim 4, wherein the glyoxal is added to the milled xanthan particles at a range of about 1,000 ppm to 10,000 ppm.

6. The process of claim 4, wherein the hydration suppression is a salt or a blend of salts.

7. The process of claim 5, wherein.the liquefied glyoxal salt composition comprises about 20-30% glyoxal, about 40-50% water, and about 20-40% salt, by total weight percent of the composition.

8. The process of claim 6, wherein the salt is selected from the group consisting of calcium chloride, magnesium chloride, and sodium chloride.

9. The process of claim 8, wherein the salt is calcium chloride.

10. The process of claim 8, wherein the liquefied glyoxal composition is added to the milled xanthan particles at a range of about 3,750 ppm to about 37,500 ppm.

11. The process of claim 10, wherein the liquefied glyoxal composition comprises about 3,000 ppm glyoxal, about 4,500 ppm water, and about 3,750 ppm salt.

12. The process of claim 4, wherein the liquefied glyoxal composition comprises a mixture of glyoxal, water and an alcohol or ketone.

13. The process of claim 12, wherein the liquefied glyoxal composition comprises about 12-24% glyoxal, about 18-36% water, and about 40-70% alcohol or ketone, by total weight percent of the composition.

14. The process of claim 13, wherein the alcohol or ketone is selected from the group consisting of polyethylene glycol, isopropanol and acetone.

15. The process of claim 14, wherein the alcohol is isopropanol.

16. The process of claim 14, wherein the ketone is acetone.

17. The process of claim 13, wherein the liquefied glyoxal composition is added to the milled xanthan particles at a range of 4,170 ppm to about 83,300 ppm.

18. The process of claim 17, wherein the liquefied glyoxal composition comprises about 7,500 ppm water, about 5,000 ppm glyoxal, and about 12,500 ppm alcohol or ketone.

19. The process of claim 4, further comprising the step of spraying the liquefied glyoxal composition onto the milled xanthan particles while blending.

20. The process of claim 19, further comprising the step of heating the treated xanthan particles to a temperature range of about 100° F. (38° C.) to about 212° F. (100° C.).

21. The process of claim 19, further comprising the step of heating the treated xanthan particles to a temperature range of about 130° F. (54° C.) to about 200° F. (93° C.).

22. The process of claim 20, further comprising the step of sifting the treated xanthan particles to an appropriate mesh size.

23. The process of claim 22, further comprising the step of adjusting pH of the liquefied glyoxal composition to a range of pH 1-2.5.

24. A dispersable xanthan product produced by the process of claim 20.
